(19) United States
(12) Patent Application Publication
(10) Pub. No.: US 2005/0038693 A1
(43) Pub. Date: Feb. 17, 2005

(54) Technical sales systems and methods

(76) Inventor: Philip J. Janus, Acton, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/877,425

(22) Filed: Jun. 25, 2004

Related U.S. Application Data
(60) Provisional application No. 60/485,320, filed on Jul. 7, 2003.
(60) Provisional application No. 60/484,082, filed on Jul. 1, 2003.

(51) Int. Cl. G06F 17/60

(52) U.S. Cl. 705/10; 705/1

(57) ABSTRACT

The present invention relates to systems and methods for managing a sales engineering process and to methods for training a sales engineer.

### CROSS REFERENCE TO RELATED APPLICATIONS

This document claims priority to, and the benefit of the filing date of, copending provisional application entitled “Technical Sales System,” assigned Ser. No. 60/485,320, filed Jul. 7, 2003, and which is hereby incorporated by reference in its entirety. This document also claims priority to, and the benefit of the filing date of, copending provisional application entitled “Technical Sales System,” assigned Ser. No. 60/484,082, filed Jul. 1, 2003, and which is hereby incorporated by reference in its entirety.

### REFERENCE TO A COMPUTER LISTING APPENDIX SUBMITTED ON A COMPACT DISK

Pursuant to 37 CFR 1.52 (e) (5), 1.77(b)(4), and 1.96, two CDs are being submitted, labelled Copy 1 and Copy 2. Copy 1 is identical to Copy 2. Both CDs include the following files: “StepsXML—Appendix A” (size 135 KB) and “SEcycleBusinessObjectsXML file—Appendix B” (size 19 1 KB), both of which are incorporated herein by reference in their entirety. The CDs were created on Jun. 25, 2004.

### BACKGROUND OF THE INVENTION

The present invention relates to Technical Sales Process Planning systems and methods. In one embodiment, this system targets previously unaddressed problems in the area of Hi-tech Sales, Technical Sales, and Sales Engineering.

A high-technology (hi-tech) sales cycle is complex and time consuming. Usually, a hi-tech sales representative (SR) follows a “sales process” to guide their sales activities. Various commercial sales methodologies have emerged over the years to support the efforts of the SR including Solution Selling®, Target Account Selling®, Miller/Heiman®, and Sandler®, to name a few. These commercial sales methodologies support complex sales cycles including the sales cycles for hi-tech products and services. Each sales methodology defines a series of 4-8 sales cycle phases such as Contact, Qualify, Develop, Close, Contract. Likewise, several Sales Force Automation (SFA) software products have emerged to support SR efforts, notably GoldMine®, ACT! ®, SalesLogix®, salesforce.com®, upshot.com®, and Siebel®, a Customer Relationship Management system.

In a hi-tech sales team, the sales representative works closely with a technically-oriented associate called the “Sales Engineer”. The Sales Engineer (SE) can have many names including Applications Engineer, Systems Engineer, Systems Consultant, Sales Support, Sales Consultant, and Pre-sales Consultant. The SE is often associated with performing product demonstrations and technical presentations. A strategic sales engineer has many other responsibilities including:
Identifying technical stakeholders in an opportunity, particularly those inaccessible to the SR. A “stakeholder” is a prospective customer who has a role in making a sales decision.
Identifying technical issues preventing the sale and resolving them
Identifying perceived technical risks and minimizing them
Verifying commercial qualification (sales-worthiness) from technical stakeholders and corroborating it with the SR's qualification
Analyzing the competition's technical strategy and eliminating them from consideration
Explaining the technology and the solution the technology provides to the customer
Explaining the value of the technology and of the solution provided by the technology
Defining a Technical Account Plan to achieve technical closure (technical closure is achieved when the customer chooses the technical solution and eliminates the competition from further consideration—At that point, the SR can then proceed with contracting).

It is noteworthy that these activities have a strong technical orientation. Though some of the SE's responsibilities may overlap with the SR's activities, the SE's technically-oriented responsibilities are largely outside the realm of the SR's expertise. Typically only an individual with both strong technical expertise and sales savvy (a unique skill set) can effectively fill the role of the Sale Engineer.

Traditional sales methodologies and sales force automation solutions do not address the unique technically-oriented needs of the Sales Engineer. Traditional solutions are purely sales focused with little, if any, technical-orientation. Specifically, traditional solutions do not take into consideration:
Technical issues and their descriptive information
Technology solutions and their descriptive information
Competitive technology and the information that characterizes the technology
The solution/feature's value resulting from specific technical functions
The Sales Engineer's Technical Sales Cycle (Process)
The technically-oriented tactics to be used to resolve technical issues and explain technical value so as to achieve technical closure
Representation of this information in a database specifically for sales engineers

To date there are no commercial offerings available for Sales Engineers—No Technical Sales Processes, no related training, no SE databases, and no Technical Account Planning Systems.

### SUMMARY OF THE INVENTION

The present invention relates to systems and methods for managing a sales engineering process and to methods for training a sales engineer. One embodiment of the invention includes four components:
a technical sales process,
technical sales process training,
a sales engineering database, called the SErepository, and
a technical account planner, called SEcycle

Embodiments of the invention support advanced features such as workflow management, automated suggestion making, and decision support functions.

In one embodiment, a technical sales process is a series of activities or steps that the Sales Engineer performs as he works through the technical sales cycle. These steps implement a series of structured best practices for sales engineers so the process is repeatable over time. High level process steps include Opportunity Analysis, Qualified Needs Analysis, Competitive Analysis, Value Analysis, and Technical Account Plan Development.

In one embodiment, technical sales process training includes providing an explanation of the objectives, details, and benefits of each process step in a technical sales process. The training makes use of a technical account planner which manages data in a sales engineering database.

In one embodiment, a sales engineering database, e.g., SErepository, is a database representation of a technical sales process and of the data required to support and monitor activities within that process.

In one embodiment, the technical account planner, SEcycle, is a visual interface to a technical sales process and implements the logic associated with analyzing plan discrepancies and performing plan development. An embodiment of the technical account planner generates a variety of reports including an Opportunity Report, Circle of Influence, Competitive Fit Matrix, and Technical Account Plan.

As noted above, traditional sales methodologies and sales force automation solutions do not address the unique technically-oriented needs of the Sales Engineer. Systems according to the invention incorporate technically-oriented aspects, described further below, of the technical sales process.

One embodiment of the invention provides a system for managing a sales engineering process. The system includes: an opportunity analysis module and a qualified needs analysis module in communication with the opportunity analysis module. The opportunity analysis module is operative to: request information identifying an opportunity; request information identifying at least one technical stakeholder associated with the opportunity; request information identifying a technical issue for each technical stakeholder; and request information identifying at least one technical issue category for the technical issue. The qualified need analysis module is operative to: request information selecting at least one stakeholder associated with the opportunity; request information identifying a qualified need associated with the selected stakeholder; and request information identifying a qualified need category for the qualified need.

In one embodiment, the technical issue category is selected from the following categories: Poor Functionality Fit, Poor Security Fit, Poor Scalability Fit, Poor Availability Fit, Poor Reliability Fit, Poor Architecture, Poor Design, Poor Requirements Definition, Poor Project Management, Poor Performance Fit, Inability to Integrate or Leverage Investments, Inability to Migrate Systems, Poor Skills or High Investment to Reskill, Inadequate Corporate Organizational Structure, 3rd Party Issues, Poor Standards Compliance, Poor Operations/Administration/Ease of Use, Inability to Test, Poor Documentation Quality, Inability to Shift Culture to ‘New World’, Unable/Unwilling to Understand the Technology, Biased Toward a Competitor, Experienced Previous Failure, Post-Sale Costs and Investment will be Large, and The Competition has a Better Technical Fit.

Similarly, in one embodiment the qualified need category is selected following categories: Architecture, Design, Requirements Definition, Project Management, Performance Fit, Integration or Leveraging Investments, Migrating Systems, Skills or Reskilling, Corporate Organizational Structure, 3rd Parties, Application or Systems Functionality, Security, Scalability, Reliability, Availability, Standards Compliance, Operations/Administration/Ease of Use, Testing, Documentation Quality, Shifting the Culture to ‘New World’, Understanding the Technology, Competitive Bias, Previous Failure, Post-Sale Costs and Investment, and The Competition has a Better Technical Fit.

In one embodiment, the opportunity analysis module: requests information identifying a technical decision maker; requests information identifying at least one other technical stakeholder; and requests information defining at least in part a relationship between the technical decision maker and the at least one other technical stakeholder.

The system can further include a competitive analysis module in communication with the opportunity analysis module. The competitive analysis module is operative to: request information selecting a stakeholder; request information selecting a qualified need of the stakeholder; and request information identifying a competitor's qualified solution associated with the selected qualified need.

In one embodiment, the competitive analysis module is operative to: request information selecting a technical issue; and request information identifying a response for the selected technical issue.

The system can further include a value analysis module in communication with the opportunity analysis module. The value analysis module is operative to: request information selecting a stakeholder; request information selecting a qualified need associated with the selected stakeholder; request information determining the value of the selected qualified need; and request information selecting a qualified solution associated with the selected qualified need.

The system can further include a technical account plan module in communication with the opportunity analysis module. The technical account plan module is operative to: request information identifying an opportunity; request information identifying a commercial sales strategy for the opportunity; request information identifying a technical closing event for the opportunity; request information identifying priority of technical stakeholders within the opportunity; request information identifying subplans that will facilitate a sale to a technical stakeholder; request information identifying technical tactics within subplans that will meet specific technical decision criteria for specific technical stakeholders; request information identifying competitive messages and value messages for technical tactics to assist in meeting those technical decision criteria; and request information identifying for each tactic: start dates, durations, resources required, and technical decision criteria to be met.

Another embodiment of the invention provides a sales engineering process including: performing an opportunity analysis and performing a qualified needs analysis associated with the opportunity analysis. Performing the opportunity analysis includes: identifying an opportunity; identifying at least one technical stakeholder associated with the opportunity; for each technical stakeholder, identifying a technical issue; and identifying at least one technical issue category for the technical issue. Performing the qualified needs analysis includes: selecting at least one technical stakeholder; identifying a qualified need associated with the selected technical stakeholder; and identifying a qualified need category for the qualified need.

In one embodiment of the sales engineering process, account flaws are detected early through account qualification (information gathering). The process can use Checklists for qualification questions. In one embodiment, the process facilitates creation of a model of the information for the decision process and a listing of stakeholders in the decision process. The process can share information and facilitate collaboration among users. The process can facilitate re-use from past accounts. In addition, the process can document information to facilitate consistency and re-use.

In another embodiment, the process can develop a technical closure project plan from the information. The process can facilitate dividing-and-conquering decision criteria. The project plan is reverse engineered backward from technical closure to create a least-cost execution plan.

The process can incorporate peer walkthroughs of the plan and its execution. Ideas are tested in the walkthroughs. Technical closure results are measured and results are fed back into the process.

An objective of the technical sales process planning system is to provide a repeatable, automated system for Sales Engineers (SE) to record and plan their sales opportunity activities. As noted above, SE activities are different from activities performed by Sales Representatives and SE activities are not addressed by traditional solutions. There are numerous benefits provided by embodiments of the invention:
The Technical Account Plan results in efficient and predictable technical closures (technical closure is achieved when a customer chooses one's technical solution and eliminates the competition from further consideration)
The systems and methods of the invention:
   encourage complete gathering of SE intelligence for technical qualification;
   facilitate identification of missing information including flagging of particularly relevant missing information;
   enable re-use SE intelligence gathered from historical opportunities;
   ensure responses to technical issues and technical value messages are aligned with stakeholder profiles
   ensure that technical issues and qualified needs are addressed by tactics;
   compare the SE's technical fit to the competition's technical fit;
   expose long and costly tactics; and
   expose technical sales patterns allowing an SE to refine his approach and to repeat successful tactics.
      As a result:
SEs do not spend time on accounts that are not ready to buy
SEs do not spend time on accounts that lack technical fit
SEs do not perform time intensive tasks such as presentations and demos on accounts that are unqualified
SEs stay focused on the technical close
Tactics chosen the by SE are aligned with the target stakeholder's profile such as their personality and level of risk taking
Tactics chosen the by SE measurably move the account forward
Technical sales cycles are consistent and follow the same process
SEs re-use Sales intelligence, strategies, and tactics from previous accounts
A closed loop process enables the effectiveness of previous strategies and tactics to be considered in future account plan development
SEs make efficient use of their time
Managers can examine SE resource utilization, performance, productivity, trends, and forecasting reports to better manage the efficiency and usage of their SEs
Sophisticated SEs and managers may ask “ad hoc” decision support questions in anticipation of situations they might encounter in a new opportunity
The SE's “cost of sales” becomes more predictable based on empirical evidence

### BRIEF DESCRIPTION OF THE ILLUSTRATED EMBODIMENTS

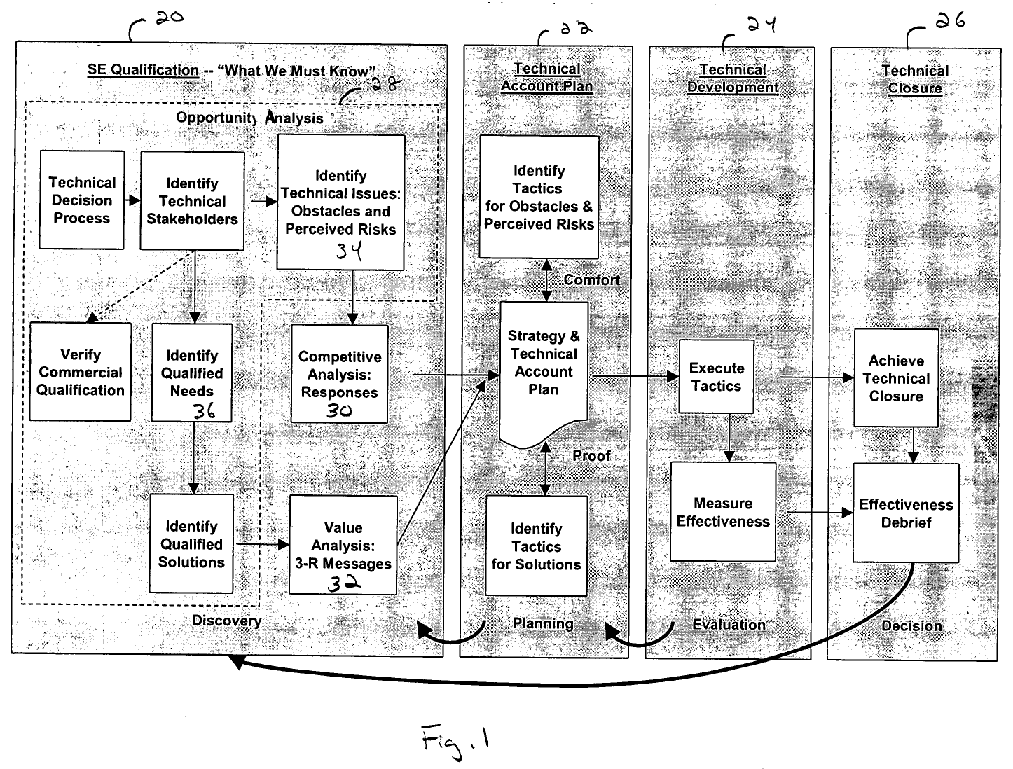

FIG. 1 is a schematic illustration of one embodiment of a Technical Sales Process according to the invention;

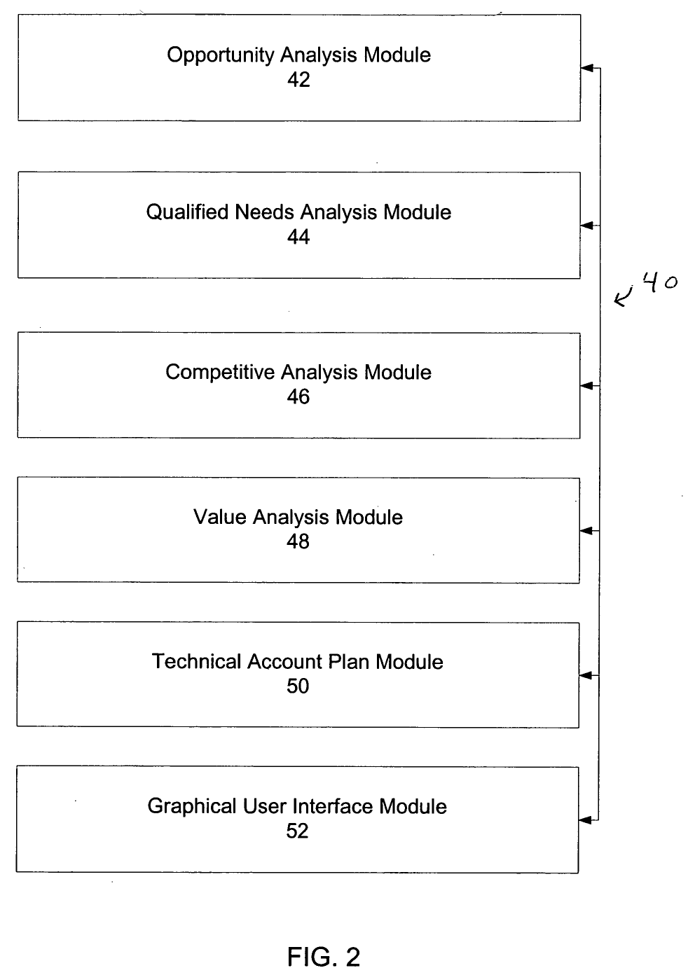

FIG. 2 shows one embodiment of a technical account planner system for implementing the process of FIG. 1;

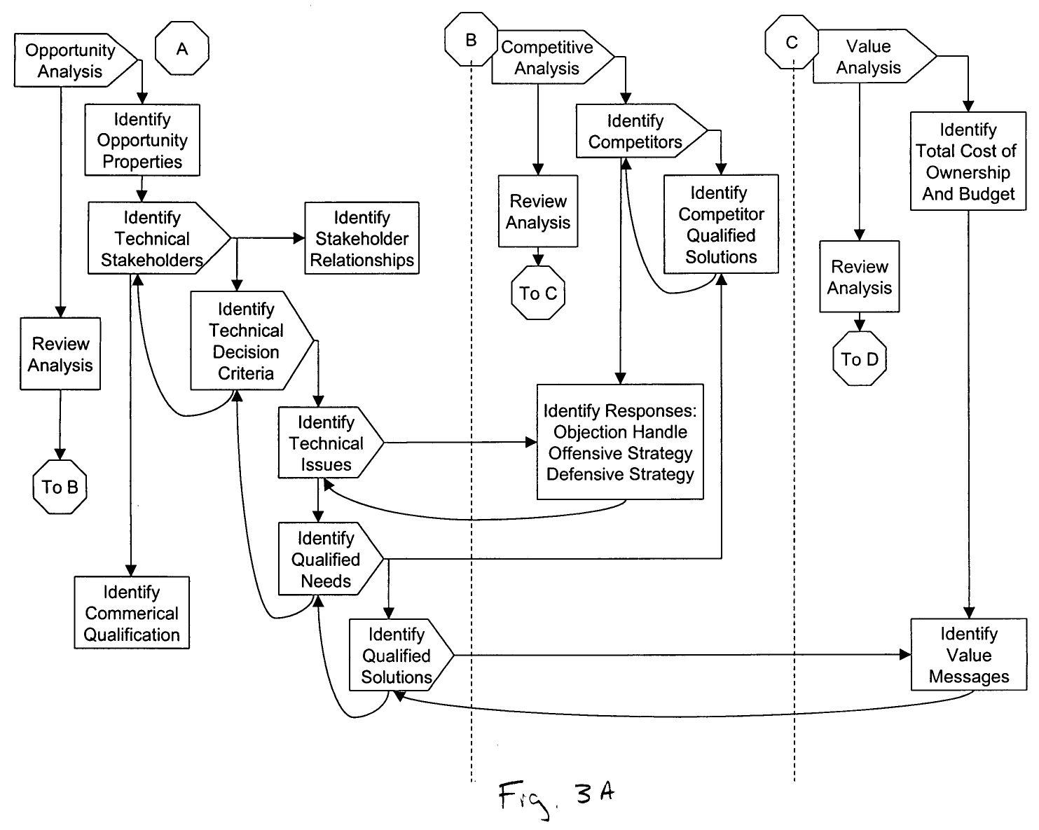

FIGS. 3A and 3B illustrate an embodiment of the Technical Sales Process of FIG. 1;

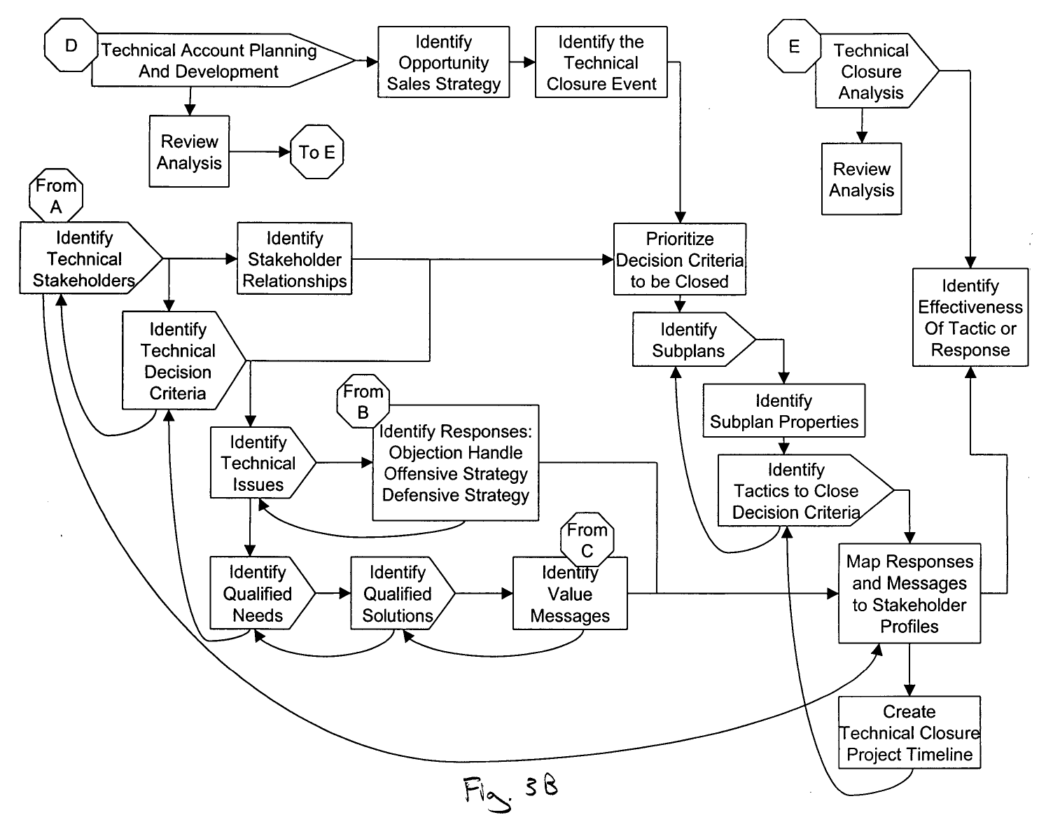

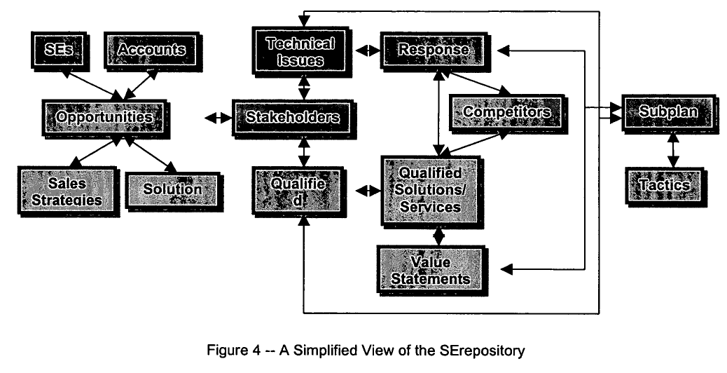

FIG. 4 is a simplified view of one embodiment of SErepository, a sales engineering database for use in performing the process of FIG. 1;

FIG. 5 illustrates one embodiment of a database structure for the sales engineering database of FIG. 4;

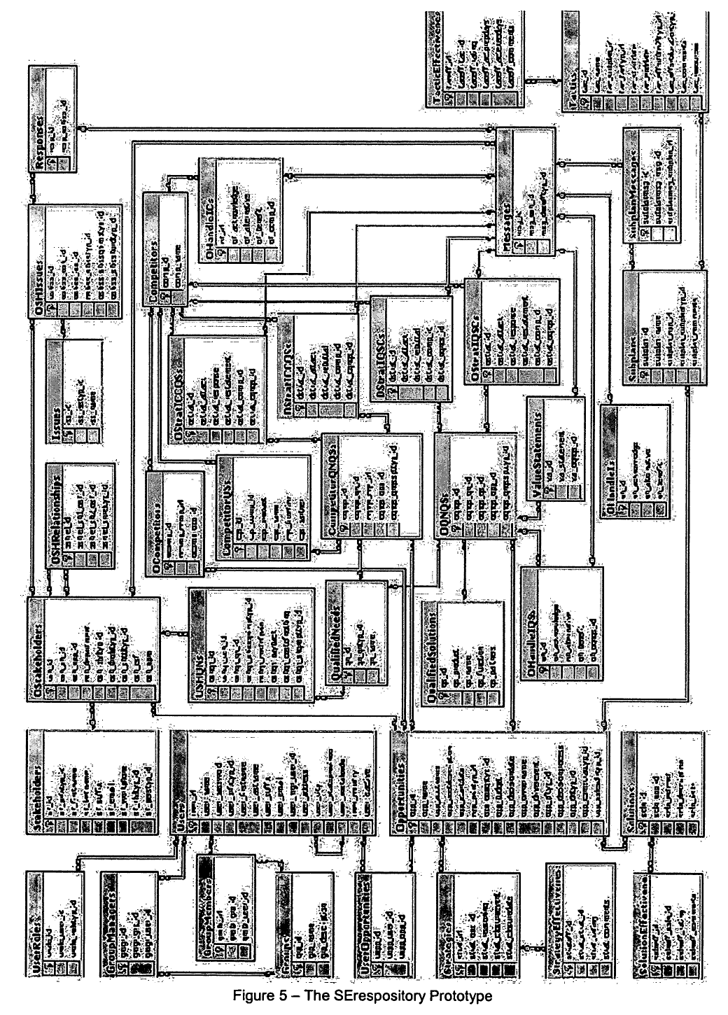

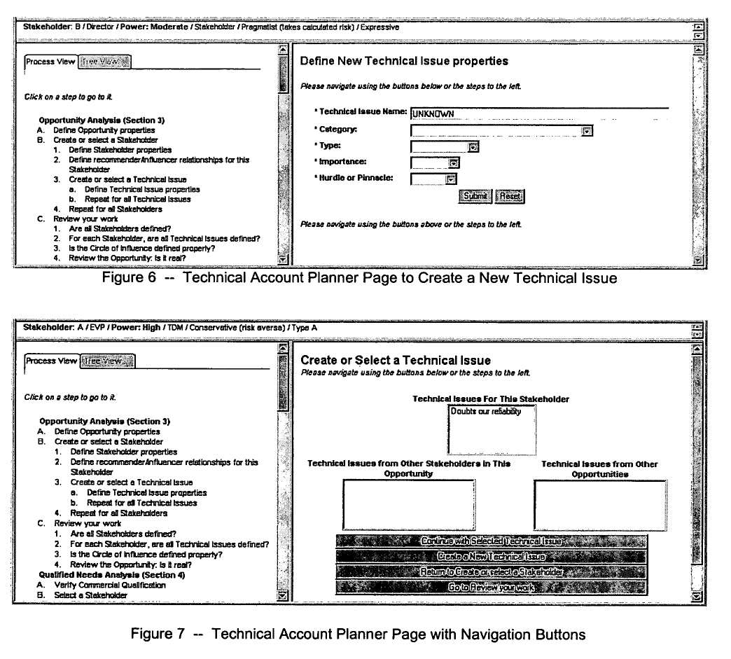

FIG. 6 shows one embodiment of a screen shot of a graphical user interface (GUI) for the Technical Account Planner system of FIG. 2; the GUI facilitates entry of a new opportunity;

FIG. 7 shows one embodiment of a screen shot of a GUI provided by the Technical Account Planner (TAP) system of FIG. 2; the GUI contains navigation buttons to guide the user to the allowable next steps of the process;

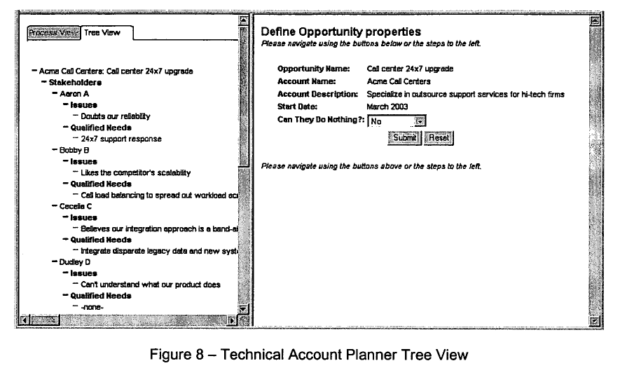

FIG. 8 shows one embodiment of a screen shot of a GUI provided by the TAP system of FIG. 2; the GUI includes a tree view of objects in the technical account planner;

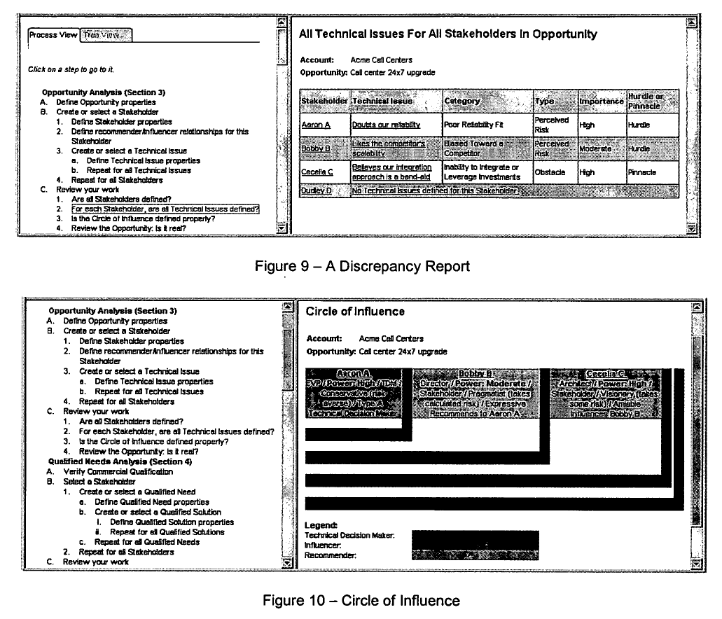

FIG. 9 shows one embodiment of a Discrepancy Report produced by the TAP system of FIG. 2;

FIG. 10 shows one embodiment of a Circle of Influence report produced by the TAP system of FIG. 2; this report guides an SE with regard to the order in which technical stakeholders' technical issues and qualified needs should be addressed;

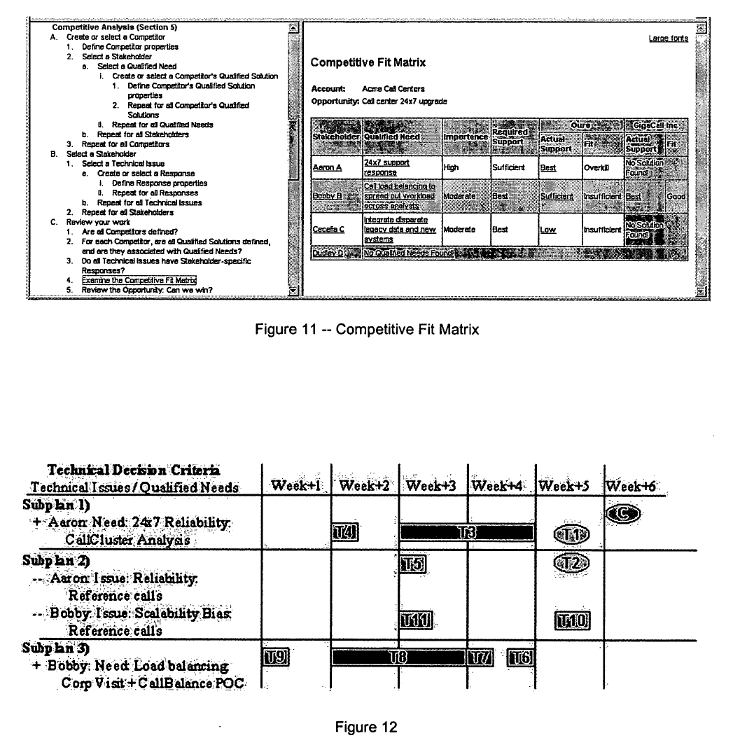

FIG. 11 shows one embodiment of a competitive fit matrix produced by the TAP system of FIG. 2; this matrix compares the technical fit of the SE's solution to the competition's technical fit;

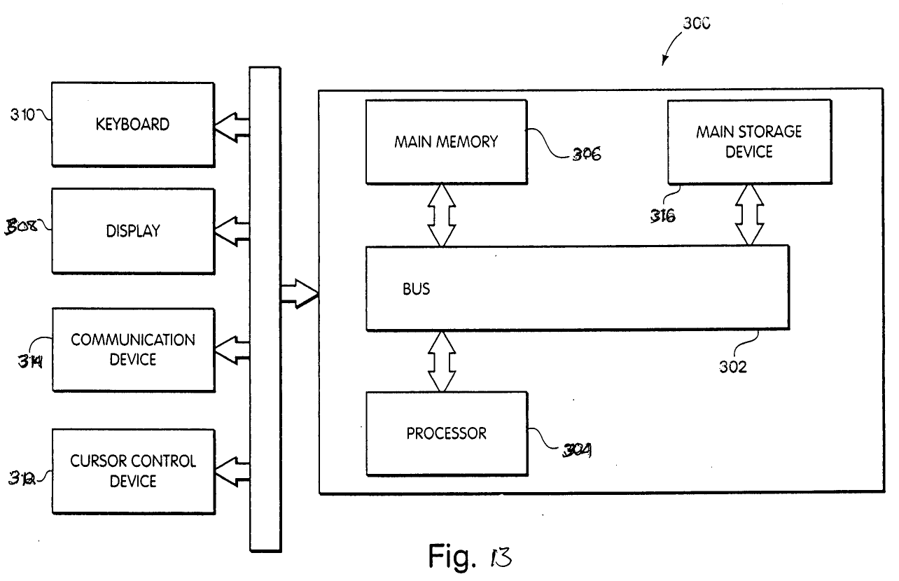

FIG. 12 shows one embodiment of a Technical Account Project Plan produced by the TAP system of FIG. 2; and

FIG. 13 is a block diagram showing a computer system for implementing one embodiment of the present invention.

### DETAILED DESCRIPTION OF THE INVENTION

The present invention relates to systems and methods for managing a sales engineering process and to methods for training a sales engineer. The invention contemplates: Technical Account Planner (TAP) systems; Technical Sales Processes, Technical Sales Process Training methods, and a Sales Engineering Database.

The Technical Sales Process

With reference to FIG. 1, the Technical Sales Process is divided into 4 phases: SE Qualification 20, Technical Account Planning 22, Technical Development 24, and Technical Closure 26.
The SE Qualification phase includes analyzing the opportunity for sales-worthiness. It is divided into 3 sub-phases: Opportunity Analysis 28, Competitive Analysis 30, and Value Analysis 32.
Opportunity Analysis 28 is a phase that analyzes the opportunity itself to determine if there is sufficient technical reason for continuing with the sales process. For example, identification of a technical decision process, technical qualified solutions (solutions the customer is willing to pay for), and identification of technical issues. A lack of a decision process or qualified solution could be cause for discontinuing the sales process, as could the presence of a non-solvable technical issue.

Opportunity analysis identifies the elements that drive the stakeholder's technical decision process, notably technical issues preventing the sale and qualified needs (a need the technical stakeholder's organization must pay to fix). Identification of these items facilitates the technical sale. The Technical Sales Process Planning System separates technical issue identification 34 and qualified need analysis 36 into two phases.

Competitive Analysis 30 determines if an opportunity can be won in comparison to the technical merits of the competition. The system creates a competitive fit matrix. Factors that determine technical fit include the importance of a need to the stakeholder, the level of support required by the stakeholder for the solution to support their qualified need, and the extent to which the solution actually does support their qualified need. In one embodiment, possible values describing the fit are Best, Sufficient, Insufficient, and Overkill. The following table reflects one embodiment of a method for determining technical fit.

| Importance | Support | Extent Of | Fit |
|---|---|---|---|
| High | + Best | A+ Differentiated | Good Fit |
| High | + Best | + Best | Good Fit |
| High | + Best | = Sufficient | Insufficient |
| High | + Best | −− Low | Insufficient |
| High | = Sufficient | A+ Differentiated | Good Fit |
| High | = Sufficient | + Best | Overkill |
| High | = Sufficient | = Sufficient | Good Fit |
| High | = Sufficient | −− Low | Insufficient |
| High | −− Low | A+ Differentiated | Good Fit |
| High | −− Low | + Best | Overkill |
| High | −− Low | = Sufficient | Good Fit |
| High | −− Low | −− Low | Good Fit |
| Moderate | + Best | A+ Differentiated | Good Fit |
| Moderate | + Best | + Best | Good Fit |
| Moderate | + Best | = Sufficient | Insufficient |
| Moderate | + Best | −− Low | Insufficient |
| Moderate | = Sufficient | A+ Differentiated | Good Fit |
| Moderate | = Sufficient | + Best | Good Fit |
| Moderate | = Sufficient | = Sufficient | Good Fit |
| Moderate | = Sufficient | −− Low | Insufficient |
| Moderate | −− Low | A+ Differentiated | Good Fit |
| Moderate | −− Low | + Best | Overkill |
| Moderate | −− Low | = Sufficient | Good Fit |
| Moderate | −− Low | −− Low | Good Fit |
| Low | + Best | A+ Differentiated | Good Fit |
| Low | + Best | + Best | Good Fit |
| Low | + Best | = Sufficient | Low Fit but |
| Low | + Best | −− Low | Insufficient |
| Low | = Sufficient | A+ Differentiated | Good Fit |
| Low | = Sufficient | + Best | Good Fit |
| Low | = Sufficient | = Sufficient | Good Fit |
| Low | = Sufficient | −− Low | Low Fit but |
| Low | −− Low | A+ Differentiated | Good Fit |
| Low | −− Low | + Best | Overkill |
| Low | −− Low | = Sufficient | Good Fit |
| Low | −− Low | −− Low | Good Fit |

The competitive analysis phase also identifies responses to technical issues since many responses have a competitive component.
Value Analysis 32 identifies the stakeholder's cost of their need due to their current inferior technical environment and their desired value payback for a new technical solution. The system creates a Value Fit Matrix to determine the extent of the SE's value fit to the stakeholder's requirements. One embodiment of a method for determining a value fit is the following:
   A) Identify the quantified qualified need (business requirement) to be satisfied
   B) Identify the quantified value our qualified solution can provide Determine the extent to which B is greater than A:
      If B is more than 20% larger than A, there is a Good Fit
      If B is at least 10% and less than 20% larger than A, there is an Adequate Fit
      If B is at least 0% and less than 10% larger than A, there is an Equitable Fit
      If B is between 0 and 10% less than A, there is Insufficient Fit
      If B is more than 10% less than A, there is a Poor Fit
Technical Account Planning 22 applies the information gathered during SE Qualification to develop a specific Technical Account Plan. The system requests identification of tactics to assist stakeholders in making their technical decision. The system requests identification of tactics to resolve technical issues preventing the sale, and the identification of tactics to explain the value of technical solutions thereby addressing qualified needs.
The Technical Development phase 24 monitors the execution of the tactics and measures their effectiveness. During technical development, an SE can disqualify an opportunity. In this case, it is necessary to regress back to the SE Qualification phase and perform further analysis to assure the technical sales-worthiness of the opportunity.
The Technical Closure phase 26 facilitates assessment of subplans and tactics for their effectiveness in a closed-loop feedback fashion. The system facilitates use of subplan and tactic assessment information so that future choices of subplans and tactics become more effective and so that the system can suggest subplans and tactics automatically.

With reference to FIG. 2, one embodiment of a technical account planner (TAP) system 40 for implementing the process of FIG. 1 includes an opportunity analysis module 42 operative to: request information identifying an opportunity; request information identifying at least one technical stakeholder associated with the opportunity; request information identifying a technical issue for each technical stakeholder; and request information identifying at least one technical issue category for the technical issue. The TAP system further includes a qualified needs analysis module 44 in communication with the opportunity analysis module. The qualified need analysis module is operative to: request information selecting at least one stakeholder associated with the opportunity; request information identifying a qualified need associated with the selected stakeholder; and request information identifying a qualified need category for the qualified need.

The TAP system can further include a competitive analysis module 46 in communication with the opportunity analysis module. The competitive analysis module is operative to: request information selecting a stakeholder; request information selecting a qualified need of the stakeholder; and request information identifying a competitor's qualified solution associated with the selected qualified need.

The TAP system can further include a value analysis module 48 in communication with the opportunity analysis module. The value analysis module is operative to: request information selecting a stakeholder; request information selecting a qualified need associated with the selected stakeholder; request information determining the value of the selected qualified need; and request information selecting a qualified solution associated with the selected qualified need.

The TAP system can further include a technical account plan module 50 in communication with the opportunity analysis module. The technical account plan is operative to: request information identifying an opportunity; request information identifying a commercial sales strategy for the opportunity; request information identifying a technical closing event for the opportunity; request information identifying priority of technical stakeholders within the opportunity; request information identifying subplans that will facilitate a sale to a technical stakeholder; request information identifying technical tactics within subplans that will meet specific technical decision criteria for specific technical stakeholders; request information identifying competitive messages and value messages for technical tactics to assist in meeting those technical decision criteria; and request information identifying for each tactic: start dates, durations, resources required, and technical decision criteria to be met.

In addition, the TAP system 40 can include a graphical user interface (GUI) module 52 that, in one embodiment, is in communication with all of the modules described above. The GUI module is operative to obtain information from the TAP system and to provide a variety of displays to system users as described in greater detail below.

Having provided an overview of a technical sales process and of a TAP system used to facilitate implementation of such a process, a more detailed discussion of one embodiment of a technical sales process is now provided with reference to FIGS. 3A and 3B. In the following discussion fields entered at each step are noted in parenthesis in non-bolded text.

The technical sales process includes a number of steps. Where necessary, after the name of a step additional detail is provided to describe the purpose of the step.

Within the training for the Technical Sales Process, sections 1 and 2 are introductory and tutorial in nature, while the actual steps of the process begins with section 3. For consistency, this numbering scheme is maintained here.

Steps from FIG. 1 are bolded below.

Embodiments of the invention re-use or facilitate re-use of sales intelligence from other opportunities. The following discussion notes steps where this re-use can occur by inserting [re-use] after the step. Additional notes regarding re-use are made after the conclusion of this discussion of a technical sales process.

### The Technical Sales Process (Detail)

The following provides an outline of one embodiment of a technical sales process as illustrated in FIGS. 3A and 3B.

3. Opportunity Analysis (Section 3) (Begin SE Qualification)
   A. Define Opportunity properties (Opportunity name, account name, account description, start date, can they do nothing?)
   B. Create or select a Stakeholder [re-use] (Identify Technical Stakeholders)
      1. Define Stakeholder properties
         (First name, last name, title, role in the sale, power level, personality type, risk level)
         (The default value for most ‘choice field’s “Unknown”)
         “Title” values: President, CEO, CIO, CTO, EVP, Vice President, Director, Manager, Architect, Project lead, Individual Contributor,
         Sysadmin/Network admin/DBA, Consultant/Integrator, Other)
         (“Role in the sale” values: Blocker/stopper, coach/champion, gatekeeper, stakeholder, TDM (Technical Decision Maker))
         (“Power level” values: High, moderate low)
         (“Personality type” values: Type A, expressive, analytic, amiable)
         (“Risk level” values: Enthusiast, visionary, pragmatist, conservative, skeptic)
      2. Define recommender/influencer relationships for this Stakeholder (Values: is recommended to by, is influenced by, recommends to, influences)
      3. Create or select a Technical Issue [re-use] (Identify technical issues)
         a. Define Technical Issue properties
            (Technical issue name, category, type, importance, hurdle or pinnacle) (“Category” values: Poor Functionality Fit, Poor Security Fit, Poor Scalability Fit, Poor Availability Fit, Poor Reliability Fit, Poor Architecture, Poor Design, Poor Requirements Definition, Poor Project Management, Poor Performance Fit, Inability to Integrate or Leverage Investments, Inability to Migrate Systems, Poor Skills or High Investment to Reskill, Inadequate Corporate Organizational Structure, 3rd Party Issues (Consultants, Partners, etc), Poor Standards Compliance, Poor Operations/Administration/Ease of Use, Inability to Test, Poor Documentation Quality, Inability to Shift Culture to ‘New World’, Unable/Unwilling to Understand the Technology, Biased Toward a Competitor, Experienced Previous Failure (with us or another), Post-Sale Costs and Investment will be Large, The Competition has a Much Better Technical Fit, ‘Cost/Price’ is NOT a Technical SE Issue, Other)
         (“Type” values: Obstacle, perceived risk)
         (“Importance” values: High, moderate, low)
         (“Hurdle or pinnacle” values: Hurdle, pinnacle)
         b. Repeat for all Technical Issues
      4: Repeat for all Stakeholders
   C. Review your work (Section 5.1.3 of this document will show sample displays of these reports)
      1. Are all Stakeholders defined?
      2. For each Stakeholder, are all Technical Issues defined?
      3. Is the Circle of Influence defined properly?
      4. Review the Opportunity: Is It Real?
4. Qualified Needs Analysis (Section 4) (Opportunity analysis continues)
   A. Verify Commercial Qualification (Technical decision process, verify commercial qualification) (Pain, qualified need, budget, decision date, owner name, possible fit, driver event, decision process) (“Pain”, “Qualified need”, “Possible fit” values: Clearly identified, Not clearly identified)
B. Select a Stakeholder
   1. Create or select a Qualified Need [re-use] (Identify qualified needs)
      a. Define Qualified Need properties
         (Qualified need name, category, importance, required support) (“Category” values: Architecture, Design, Requirements Definition, Project Management, Performance Fit, Integration or Leveraging Investments, Migrating Systems, Skills or Reskilling, Corporate Organizational Structure, 3rd Parties (Consultants, Partners, etc), Application or Systems Functionality, Security, Scalability, Reliability, Availability, Standards Compliance, Operations/Administration/Ease of Use, Testing, Documentation Quality, Shifting the Culture to ‘New World’, Understanding the technology, Competitive Bias, Previous Failure (with us or an other), Post-Sale Costs and Investment, The Competition has a Much Better Technical Fit, ‘Cost/Price’ is NOT a Need; It is a desire, other) (“Importance” values: High, moderate, low) (“Required support” values: Low, sufficient, best)
      b. Create or select a Qualified Solution [re-use] (Identify qualified solutions)
         i. Define Qualified Solution properties (Qualified solution name, function, product, partners, extent of support for need) (“Extent of support for need” values: Low, sufficient, best, differentiated)
         ii. Repeat for all Qualified Solutions
      c. Repeat for all Qualified Needs
   2. Repeat for all Stakeholders
C. Review your work (Section 5.1.3 of this document will show sample displays of these reports)
   1. Review Commercial Qualification
   2. For each Stakeholder, are all Qualified Needs defined?
   3. For each Qualified Need, are all Qualified Solutions defined?
   4. Examine the Competitive Fit Matrix
   5. Review the Opportunity: Is It Real?
5. Competitive Analysis (Section 5) (Competitive analysis: Responses)
Responses to technical issues are defined in this section. There are three types of responses: Objection Handle, Offensive Strategy, and Defensive Strategy. Offensive and defensive strategies require both a competitor and a (competitor's) Qualified Solution. Objection handles may be associated with:
   Only a Technical Issue (“Your tech support is awful.”)
   Only a Competitor (“Your competitor's tech support is great!”)
   Only a Qualified Solution (“XYZ feature doesn't give me the functionality I need.”)
The flow of this section is:
If a competitor is associated with the response and they are already defined, go to step B to define a response. This may be common.
If an objection handle is to be defined that does not require a competitor, go to step B. (Step A) Define a competitor.
   Define the competitor's qualified solutions. Qualified solutions are always associated with a stakeholder's qualified needs.
(Step B) Define a response to a technical issue. See additional detail below. Each technical issue for each stakeholder should have a response defined.
A. Create or select a Competitor
   1. Define Competitor properties
      (Competitor name)
   2. Select a Stakeholder
      a. Select a Qualified Need
         i. Create or select a Competitor's Qualified Solution
            1. Define Competitor's Qualified Solution properties (Competitor's qualified solution name, function, product, partners, extent of support) (“Extent of support” values: Low, sufficient, best, differentiated)
            2. Repeat for all Competitors' Qualified Solutions
         ii. Repeat for all Qualified Needs
      b. Repeat for all Stakeholders
   3. Repeat for all Competitors
B. Define the Response, begin by Selecting a Stakeholder
   1. Select a Technical Issue
      a. Create or select a Response [re-use]
         i. Define Response properties—There are seven choices:
            Objection Handle associated with:
            1. This technical issue (Acknowledge, alternative, benefit, desired effect) (“Desired effect” values: Attack, neutralize)
            2. This technical issue and a competitor (Competitor, acknowledge, alternative, benefit, desired effect)
            3. This technical issue and a qualified solution (Qualified solution, acknowledge, alternative, benefit, desired effect)
            Offensive Strategy associated with:
            4. Our strength: This technical issue, a qualified solution and a competitor (Our qualified solution, competitor, attack, response, restatement, desired effect)
            5. Their weakness: This technical issue, a competitor and a competitor's qualified solution (Competitor, competitor's qualified solution, attack, response, restatement, desired effect)
            Defensive Strategy associated with:
            6. Our weakness: This technical issue, a qualified solution and a competitor (Our qualified solution, competitor, attack, rebuttal, desired effect)
            7. Their strength: This technical issue, a competitor and a competitor's qualified solution (Competitor, competitor's qualified solution, attack, rebuttal, desired effect)
         ii. Repeat for all Responses
      b. Repeat for all Technical Issues
   2. Repeat for all Stakeholders
C. Review your work (Section 5.1.3 of this document will show sample displays of these reports)
   1. Are all Competitors defined?
   2. For each Competitor, are all Qualified Solutions defined, and are they associated with Qualified Needs?
   3. Do all Technical Issues have Stakeholder-specific Responses?
   4. Examine the Competitive Fit Matrix
   5. Review the Opportunity: Can we win?
6. Value Analysis (Section 6) (Value analysis: 3-R messages)
   A. Enter Opportunity Budget (Budget, estimated solution cost)
   B. Select a Stakeholder
      1. Quantify the Stakeholder's Performance Metrics (Critical success factors, operational performance metrics)
      2. Select a Qualified Need
         a. Enter the Value or Cost of the Stakeholder's Qualified Need (Cost of pain, desired payback, cost of doing nothing)
         b. Select a Qualified Solution
            i. Create or select a 3-R Value Statement [re-use]
            1. Define 3-R Value Statement properties (Statement, desired effect) (“Desired effect” values: Attack, neutralize)
            2. Repeat for all 3-R Value Statements
         ii. Repeat for all Qualified Solutions
      c. Repeat for all Qualified Needs
   3. Repeat for all Stakeholders
C. Review your work (Section 5.1.3 of this document will show sample displays of these reports)
   1. Does every Qualified Solution have Stakeholder-specific 3-R Value Statements?
   2. Examine the Value Fit Matrix
   3. Review the Opportunity: Is it worth it?
      This is the conclusion of SE Qualification
7. Technical Account Plan Development (Section 7) (Strategy and technical account planning)
   A. Enter Opportunity Sales Strategy (Circle direction, commercial sales strategy, reasoning, closure date, closure event) (“Circle direction” values: Inside-out, Outside-in, Parallel) (“Commercial sales strategy” values: Change the criteria, establish a beachhead, Attack, Defend, Walk)
   B. Create or select a Subplan [re-use]
      1. Define Subplan Properties
         (Name, category, comments)
            (“Category” values: Acceptance test, Benchmark, Corporate visit, Customer support, Demonstration, Email, Install/patch, Onsite support, Phone call, Presentation (and demo), Proof-of-concept, Reference call, Research, RFPs, Sales meeting, Seminar, Send documentation, Service, Training, Trial, Voice mail, Other)
      2. Select Messages for this Subplan
         Selecting a competitive response automatically associates the response's technical issue with the Subplan. The subplan should then define tactics to resolve the technical issue.
         Select a 3-R value message automatically associates the 3-R's qualified need with the Subplan. The subplan should then define tactics to explain the value of the qualified need's qualified solutions.
      3. Create or select a Tactic [re-use] (Identify tactics for obstacles and perceived risks, identify tactics for solutions)
         a. Define Tactic properties
            (Name, category, comments, resources, start date, end date, effort)
            (“Category” values: Acceptance test, Benchmark, Corporate visit, Customer support, Demonstration, Email, Install/patch, Onsite support, Phone call, Presentation (and demo), Proof-of-concept, Reference call, Research, RFPs, Sales meeting, Seminar, Send documentation, Service, Training, Trial, Voice mail, Other)
         b. Repeat for all Tactics
      4. Repeat for all Subplans
C. Review your work (Section 5.1.3 of this document will show sample displays of these reports)
   1. Do all Technical Issues have at least one Response that is used in a Subplan?
   2. Do all Qualified Solutions have at least one 3-R Value Statement that is used in a Subplan?
   3. Review the Opportunity
   4. Review the Technical Account Plan
      The SE executes the tactics. The SE continually reviews and updates the technical account plan as the dynamics in the opportunity changes.
8. Technical Closure and Technical Account Plan Debrief (Section 8) (Achieve technical closure, effectiveness debrief)
   A. Enter the Technical Closure status, date, and effectiveness of the Opportunity Sales Strategy (Status, closure date, strategy effectiveness, comment) (“Status” values: Technical win, technical loss, technical stall, commercial loss, commercial stall, no decision)
      (“Strategy effectiveness” values: High, moderate, low)
   B. Select a Subplan
      1. Select a Message used in this Subplan
         a. Enter the Message's effectiveness for the stakeholders in this Subplan (Effectiveness, comment) (“Effectiveness” values: High, moderate, low)
         b. Repeat for all Messages
      2. Select a Tactic used in this Subplan
         a. Enter the actual timing of the Tactic and its effectiveness for the stakeholders in this Subplan (Actual start date, actual end date, actual effort, effectiveness, comment) (“Effectiveness” values: High, moderate, low)
         b. Repeat for all Tactics
      3. Repeat for all Subplans
C. Review your work (Section 5.1.3 of this document will show sample displays of these reports)
   1. Has the Technical Closure date and strategy effectiveness been entered?
   2. Have all messages used in the Technical Account Plan have an effectiveness rating?
   3. Have all tactics in the TAP been given a timing and effectiveness rating?

Novice SEs follow the Technical Sales Process flow sequentially step by step as suggested by the Technical Account Planner visual interface. However, the Technical Sales Process is free flowing; advanced SEs may jump out of one step and go into any other second-level step, for example, the SE could jump from step 6.B.2.b. 1 and go to 3.B described above.

Workflow: Not shown or described in FIGS. 3A and 3B is the notion of workflow. The Technical Sales Process defines an explicit SE workflow. The system is designed to easily extend the workflow once objects are defined in the SErepository. (In one embodiment a customer, i.e., a user of a system according to the invention can define these extensions). The high level phases of the Technical Sales Process are well defined—Opportunity Analysis, Qualified Need Analysis, Competitive Analysis, Value Analysis, Technical Account Plan Development, and Technical Closure (most simply defined by sections 3 through 8).

One embodiment of the Technical Sales Process Planning System monitors where the SE is in the workflow and monitors the timing of the activities. The system contains a workflow queuing system and automated submission/approval process. The system enables the SE to submit his work to his manager or sales representative for review. The reviewer has the option of reviewing the SE's queue of work, review an opportunity, comment, and then approve or deny the opportunity. The reviewer also has the ability to prevent the SE from continuing to a future section, or to return the SE to a prior step.

Maintaining timing information enables a variety of useful management level forecasting, trend, productivity, and performance reports such as:
Forecasting
Wins/losses/stalls
Wins/losses/stalls by competitor
Elapsed time in the process
Elapsed time in the process per SE or SE team
Elapsed time per phase
Elapsed time per phase per SE or SE team
Revenue per phase
Revenue per phase per SE or SE team
Revenue per elapsed time
Any of the above over time (trend analysis)

Re-use and Suggestion Making: Re-use has at least two implications in the Technical Sales Process Planning System. First, information from prior opportunities may be explicitly re-used such as information regarding prior stakeholders, qualified needs, qualified solutions, and subplans. Secondly, using the knowledge the system retains from prior opportunities, the system can automatically suggest choices for qualified solutions, competitive responses, value messages, subplans, and tactics. As examples, the following suggestions are possible:
For a stakeholder with a certain personality, a certain level of risk-aversion, and a particular qualified need, here are suggested qualified solutions the system has seen before.
For a stakeholder with a certain personality and a certain level of risk-aversion, for a particular technical issue category, and where a certain competitor is present, here are suggested competitive responses that have been highly effective (from technical closure debriefs (section 8)).
For a stakeholder with a certain personality, a certain level of risk-aversion, and a certain qualified need, here are suggested subplans and tactics that have been highly effective.

The Technical Sales Process Planning System is capable of leveraging prior knowledge and sales intelligence regarding past opportunities to guide the SE into creating highly effective technical account plans. The system is designed to extend the notion of re-use and question making to any object maintained within the system's database.

The Technical Sales Process Training

The Technical Sales Process Training, SEskills, is a component of the Technical Sales Process Planning System.

The following presents an outline of one embodiment of a training method referred to as SEskills. As a part of the Technical Sales Process Planning System, the outline follows the Technical Sales Process.

### SEskills Training Outline

1) Introduction—The importance of each and every tactic
2) Know Yourself—The Role of the Sales Engineer
   Definitions of Technical Selling and Sales Engineering
   Engineering the Technical Sales Cycle
   Characteristics of a Great SE
3) Know Your Customer—Is It Real? SE Qualification (1)
   Identify Technical Issues
      Technical Obstacles preventing the sale and Perceived Technical Risks
      Technical Qualification checklist
   Circle of Influence
   Stakeholder Profile
   Selling to stakeholder profiles and adjusting to personality shifts
4) Know Your Customer—Is It Real? SE Qualification (II)
   Leveraging Credibility
   Verify Commercial Qualification
      Commercial Qualification checklist
   Solution Oriented Consultative Selling
      Qualified Needs (what must the customer fix). The consequences of not actively listening
      Qualified Solutions/Products/Features/Services (what the customer will pay for)
      Identification of initial solution
5) Know Your Enemy—Can We Win It? Competitive Analysis
   Competitive fit matrix
   Responses to Technical Issues
      Objection Handling and Trap Setting
      Offensive Strategy
      Create the competitor's offensive strategy—Defensive Strategy
      Incorporating responses into Circle of Influence
6) Know Your Value—Is It Worth It? Establishing Technical Value
   Quantified Value-Oriented messages
   Value fit matrix
   Adjusting value messages to the stakeholder's profile
   Incorporating qualified solution technical value messages into Circle of Influence
7) Know How to Win—The Technical Sales Strategy and Effective Tactics Pulling it all together to create a Technical Account Plan
   Identify a Commercial Sales Strategy. Only five strategies—removes randomness Envision Technical Closure—Identify an event to close the Technical Decision Maker Prioritize order of work and events from Circle of Influence Engineer tactics into a Technical Account Plan
   Identify tactics to resolve each technical issue—Obstacles and perceived risks
   Identify tactics to explain technical value of each qualified solution
   Adjusting tactics to stakeholder's profile Working Smart—Identify Smart SE Tasks that move opportunities forward rapidly
8) Identify management-by-object (MBOs), Wrap Up. Certificates of Achievement, Evaluations

MBOs enable management to measure the SE's improvement

The SErepository

The Sales Engineering Database, SErepository, is the sales engineering database that stores all Technical Sales Process, monitoring, and workflow information. FIG. 4 shows a simplified view of the database. FIG. 5 shows a detailed view of the SErepository.

Each box in FIG. 5 is called an entity. FIG. 4 shows many of the entities within SErepository such as Opportunities, Stakeholders, and Tactics. Inside of each entity are attributes, also called fields.

Fields: A field contains data that describes the entity, so for example, first name, last name, and role in the sale are all fields of the entity Stakeholder.

Relationships: The lines between entities reflect the relationship between two entities. Note that one end of the line can have a key—a key implies a one-to-one relationship, and the other end of the line can have a double dot—a double dot implies a many-to-one relationship. Note the relationship between Opportunities and Solutions. The end of the line connecting to the solutions entity has a double dot and the end of the line connecting to the opportunity entity has a key. This is read: One opportunity has one or many solutions, and one solution has one opportunity.

Nearly all the relationships between major entities are “many-to-many” relationships. For example, one opportunity has many stakeholders, and one stakeholder belongs to many opportunities. However, due to the nature of database design implementation, the many-to-many relationship is typically not allowed to exist directly between the two entities, rather, a third “middleman” entity or what's technically called an associative entity must be created in between the original two. In the example of opportunities and stakeholders, an opportunity stakeholder entity may be created (the diagram abbreviates this to Stakeholders).

Description of high-level entities in FIG. 5: FIG. 5 is a detailed diagram of the entities and attributes (tables and fields) in the SErepository database in a prototype form. The field names may be difficult to read, but the field names in and of themselves are not the important item being communicated in the diagram, rather, the entities and their relationships to one another are more important. There are 38 entities in FIG. 5. For the sake of brevity, twenty of the high-level important entities are described below. The remainder of the entities for the most part implement many-to-many relationships or add more detail to the entities being described below:
Users: A user is a sales engineer or perhaps their manager or sales representative. This is a user of the Technical Sales Process Planning System.
Groups: A group is a grouping of Users. Perhaps a group represents all the sales engineers in one office, a region, or a continent. Groups are useful for security, system administration, and reporting purposes
Stakeholders: A stakeholder is a person who has a role in the technical decision.
Opportunities: An opportunity is a sales situation. For a sales engineer, the opportunity is typically developed to the point where initial Stakeholders are known and some initial level of commercial qualification has been performed to determine a good probability of sales-worthiness.
Qualified Needs: A qualified need is a need a Stakeholder's must pay to fix.
Qualified Solutions: A qualified solution is a solution, product, feature, or service the Stakeholder must pay for to fix their Qualified Need.
Competitors: A competitor is another vendor who is also trying to sell the Stakeholder a Qualified Solution that addresses their Qualified Needs. Competitors also have Qualified Solutions (CompetitorQSs). Sales engineers must carefully consider the technical aspects of the competition and their offerings.
Issues: An issue is a technical issue. Technical issues may be obstacles that prevent the sale, or perceived technical risks that stall the sale.
Messages: A message is a statement which will be used as either a Response to a Technical Issue or as a Value Statement to explain the value of a Qualified Solution.
Messages are usually technical in nature.
Ostrat . . . s, Dstrat . . . s, OHandle . . . s: There are seven of these entities which represent the types of Technical Issue Responses. Briefly they are:
   Offensive strategy involving our strong Qualified Solution and a Competitor
   Offensive strategy involving a Competitor and their weak Qualified Solution
   Defensive strategy involving a Competitor and their strong Qualified Solution
   Defensive strategy involving our weak Qualified Solution and a Competitor
   Objection Handle involving a Qualified Solution
   Objection Handle involving a Competitor (but no Qualified Solution)
   Objection Handle involving only a Technical Issue (no Qualified Solution nor Competitor
   Responses: A response is a statement designed to help resolve a Technical Issue. It takes one of the seven forms listed above.
   Value Statements: This is an explanation of the value of a Qualified Solution.
   Subplans: A subplan is a series of Tactics to resolve Technical Issues and address Qualified Needs (using Messages) helping the Stakeholder to make a decision.
   Tactics: A tactic is an activity that will resolve Technical Issues and/or address Qualified Needs. Tactics implicitly use Messages as they are performed.

Entities not shown in FIG. 5: Several entities are not shown in FIG. 5 notably look-ups, user-defined data, workflow, and timing/statistical entities.
Look-ups: The SErepository has many look-up entities, several of which are eluded to in FIG. 3 where lists of values are presented. Look-up lists include (but are not limited to): Role in the sale, power level, personality type, risk level, influencing role, technical issue category, technical issue type, technical issue importance, hurdle or pinnacle, qualified need category, qualified need importance, required support, extent of support, fit matrix decision tree, circle of influence direction, commercial sales strategy, subplan category, and tactic category
User-defined data: The SErepository has the ability to store new user-defined entities and user-defined fields. The database contains a set of entities that describe the user-defined data (such entities are commonly referred to as metadata). Entities include: User_entities, User_fields, User_datatypes, User_values. Examples of uses for user-defined data include technical qualification questions, the SE's experience with effective and ineffective tactics based on stakeholder profiles, and efficient SE activities.
Workflow: Entities that are useful to represent workflow include: A queue of activities, a list of activities with their submitter and their recipient, a look-up list of possible activities, a look-up list of possible actions to take based on phase and activity status, a look-up list of possible activity statuses, a look-up list of possible review statuses.
Timing: These entities include a host of information related to measuring SE performance. Examples include elapsed time per phase per SE, revenue per phase per SE, wins, and losses.

In addition, several entities are shown in FIG. 4 but not in FIG. 5 including: accounts, sales strategies, and solutions.

Decision Support: In advanced sales engineering environments, sophisticated managers want to ask decision support questions. This is a powerful and compelling benefit of the SErepository. Examples of decision support questions include:
What tactics are not being used by SEs?
How effective has a tactic been for various stakeholder profiles?
How effective have competitive responses been for a competitor?
How has a qualified need for a stakeholder profile been addressed in the past?
What has been the most effective way to explain the value of a qualified solution to a particular stakeholder profile?
In one report, for each subplan category type, show the probability of technical closure (effectiveness) and the elapsed time to technical closure (efficiency) Managers will give preference to subplans that are both effective and efficient.

External API: The SErepository supports the ability to exchange data with other sales support systems, called Sales Force Automation tools (SFA). Such an interface is usually called an Application Programming Interface (API). One can refer to this inter-SFA API SEbridge. SEbridge defines a series of information exchange messages that can be shared between disparate vendors of sales intelligence databases. SEbridge uses XML technology, a rapidly emerging web-based inter-application protocol standard. In one embodiment, the interface includes a set of self-describing network messages, substantially defined as follows:

Object := < object ID (OID) , object type , name , description >

object types := business object, result set, row (record), column (field)
object type: column := < OID , datatype , length >
object type: row := < number of columns , column OID_list >

OID_list := < array of OIDs >

Object type: result set := < number of rows, result set name, row OID_list >
Object type: business object := < result set OID list >

Action := < URL , action type , object type , OID_list >
URL could be a local or remote database server
Action type := < select , insert , update , delete , create , drop >

The Technical Account Planner

The Technical Account Planner includes a visual interface for the Technical Sales Process Planning System. The Technical Account Planner implements the steps of the Technical Sales Process in an intuitive manner.

In one embodiment, the visual interface consists of six dynamic web pages whose entry fields differ based on the information being requested for the Technical Sales Process step (as described in FIG. 3). An example of the first entry web page is shown in FIG. 6.

The visual interface displays the Technical Sales Process, an entry area, and a “context area” of related data. There are several characteristics of the interface.
Firstly, a visual display enables traversal of the Technical Sales Process, for example, in this case the steps for Opportunity Analysis (section 3) are shown in the frame on the left. The user may choose any step by clicking on it, though usually they will take the next in sequence.
Secondly, the interface enables data entry, for example, in this case in the right hand frame. The interface also may have buttons that facilitate specific navigation through the Technical Sales Process (particularly for novice users), as shown in FIG. 6 in the right hand frame.
Thirdly, the visual interface has a “context area”, as shown at the top of FIGS. 6 and 7.

The context area shows the data associated with the object being managed, so for example, the context area in FIGS. 6 and 7 displays Stakeholder data for the Technical Issue being entered. Though not shown, the context area for a Value Statement would show the Stakeholder, Qualified Need, and Qualified Solution. More specifically, with reference to FIG. 6, one can define new technical issue properties. One can input a technical issue name, a category, a type, the importance of the technical issue, and fill in a hurdle or pinnacle field. With respect to FIG. 7, one can create or select a technical issue. In the illustrated embodiment, three lists are presented including “technical issues for this stakeholder,” “technical issues from other stakeholder in this opportunity,” and “technical issues from other opportunities.” Thus one can highlight a technical issue from one of the lists and/or select from one of the following four selections: “continue with selected technical issue,” “create a new technical issue,” “return to create or select a stakeholder,” or “go to review your work.” One embodiment of the Technical Account Planner provides a hierarchical “tree view” of objects stored in the database, SErepository. A sample is shown in FIG. 8. For example, the tree view can show the hierarchical objects for Stakeholders, their Qualified Needs, their Qualified Solutions, their Value Statements, the Subplans they are in, and the Tactics in the subplan. With reference to FIG. 8, the opportunity name is Call Center 24×7 upgrade. The account name is Acme Call Centers. The tree view lists the stakeholders and associated issues and qualified needs for this account and opportunity. The Technical Account Planner includes a series of reports including those shown in FIGS. 9-13.

The Opportunity Status Report is a summary display of sales intelligence regarding the opportunity. One can assess the completeness of data gathering, particularly by looking for UNKNOWNs or NONEs as listed below next to certain fields.

### Opportunity Status Report (for Two Stakeholders)

### Opportunity Status Report Opportunity: Call center 24×7 Upgrade

Account Name: Acme Call Centers
Account Description: Specialize in outsource support services for hi-tech firms
Start Date: March 2003
Commercial Qualification:
   Cost of Pain Identified? Clearly Identified
   Qualified Need Identified? UNKNOWN
   Possible Fit: Clearly Identified
   Owner: Aaron. CFO releases the budget
   Driver Event: Project No-Dropped-Calls initiated by CEO.
   Decision Date: June 2003
   Budget: $500 k
Can They Do Nothing? No
Decision Process: Aaron makes the final call. Relies heavily on Bobby's opinion. Bobby and his staff will likely want a proof of concept.
Estimated Solution Cost: $150 k
Circle Direction: Inside-out
Commercial Sales Strategy: Establish a beachhead
Reasoning: Already have large GigaSupport system in-house. Get a small success and build from there.
Closure Date: Jun. 30, 2003
Closure Event: Proof of Concept and references for Bobby's Spreadsheet analysis and references for Aaron.
TDM: Aaron A
Profile: EVP/Power: High/Conservative (risk averse)/Type A
Recommends to: NONE
Influences: NONE
Technical Issue: Perceived Risk/Hurdle/Importance: High/Doubts our reliability
Response Type: Objection Handle
Qualified Solution: CaliCluster
Message: I understand your concern. We have several references who support 24×7 response (conservative). Here are 3 references who have been bug free for 9 months (results-oriented).
Subplan: Jun. 2, 2003-06/23/2003/Aaron—Qualified Need for Reliability. CaliCluster analysis
Tactic: Jun. 23, 2003-06/23/2003/Sales meeting/C-Ti—Meeting to review analysis
Tactic: Jun. 3, 2003-06/16/2003/Research! T3—Write analysis
Tactic: Jun. 2, 2003-06/02/2003/Service/T4—Site survey
Subplan: Jun. 9, 2003-06/22/2003/Aaron—Resolve reliability concerns. Bobby Resolve scalability concerns.
Tactic: Jun. 22, 2003-06/22/2003/Reference call/C-T2—Reference call to address technical issues
Tactic: Jun. 9, 2003-06/09/2003/Phone call/T5—AM schedules call+brief customer
Qualified Need: Importance: High/Required Support: Sufficient/24×7 support response
CSFs: Needs 99.999% availability. Improved service will increase service contracts by $500 k.
OPMs: ROI of $1M in 12 months.
Payback: New contracts $500 k
Cost of Pain: UNKNOWN
Cost of Doing Nothing: UNKNOWN
Qualified Solution: Solution Support: Best/Fit: Overkill/CallCluster 3-R: This brief analysis (type-A) shows you'll achieve 99.999% up-time (map to OPM) with our proven CallCluster (conservative). Here is the summary report of customers with more than $500 k in new contracts resulting from improved service (map to CSF).
Subplan: Jun. 2, 2003-06/23/2003/Aaron—Qualified Need for Reliability. CallCluster analysis Tactic: Jun. 23, 2003-06/23/2003/Sales meeting/C-Ti—Meeting to review analysis
Tactic: 06/03/2003-06/16/2003/Research/T3—Write analysis
Tactic: 06/02/2003-06/02/2003/Service/T4—Site survey Subplan: Jun. 9, 2003-06/22/2003/Aaron—Resolve reliability concerns. Bobby—Resolve scalability concerns.
Tactic: 06/22/2003-06/22/2003/Reference call/C-T2—Reference call to address technical issues
Tactic: 06/09/2003-06/09/2003/Phone call/15—AM schedules call+brief customer
Stakeholder: Dudley D
1. Profile: Individual Contributor/Power: Low/Enthusiast (buys beta)/Amiable
2. Recommends to: NONE
3. Influences: NONE
4. Technical Issue: Obstacle/Hurdle/Importance: High/Can't understand what our product does
5. Responses: NONE
6. Qualified Needs: NONE

Discrepancies are displayed through a variety of reports. Discrepancies typically display associations that are not being made in the sales intelligence, for example, stakeholders with no technical issues, qualified needs with no qualified solutions, qualified solutions with no value statements, and value statements not contained in any subplans. Thus, with reference to FIG. 9, in one embodiment the discrepancy report lists all technical issues for all stakeholders in a specified opportunity. For each stakeholder, a technical issue, a category, a type, an importance indication, and a hurdle or pinnacle indication is listed. Note the technical issue discrepancy in FIG. 9 lightly shaded in gray at the bottom of the display, “No Technical Issues defined for this Stakeholder”. Discrepancy Reports are contained within a series of displays throughout the technical account planner. FIG. 9 shows one of the reports containing discrepancies highlighted in gray.

With reference to FIG. 10, the Circle of Influence is a model of the decision process. The report shows who influences whom in the decision process. The report guides the SE with regard to deciding which stakeholders to work with first versus which stakeholders can be deferred. In a full circle of influence report, the stakeholder's technical issues and qualified needs are displayed showing all the factors involved in the stakeholder's decision process. More specifically, with reference to FIG. 10, one can see that Aaron A is the technical decision maker, Bobby B recommends to Aaron A, and Cecelia C influences Bobby B.

With reference to FIG. 11, the Competitive Fit Matrix compares the SE's technical fit to the competition's technical fit. Factors that determine the technical fit include the importance of the need to the technical fit stakeholder, the level of support required by the stakeholder for the solution to support their qualified need, and the extent to which the solution actually does support their qualified need. In one embodiment possible values describing the fit are Best, Sufficient, Insufficient, and Overkill. More specifically, with reference to FIG. 11, one embodiment of a competitive fit matrix lists stakeholders associated with an opportunity. This list associates with each stakeholder: a qualified need, an importance indication, a required support, and an actual support and a fit indication for both the SE's solution and the competition's solution.

The Technical Account Plan is another type of report showing the full plan of sales engineering tactics. The Technical Account Plan displays the tactics in reverse chronological order from technical closure (since planning backwards is an efficient planning approach). The report shows each stakeholder's technical issues and qualified needs to be addressed by the tactics in the subplan. The Technical Account Plan is followed by a thorough discrepancies report.

### Technical Account Plan (for One Subplan) and Discrepancies Report

### Summary Technical Account Plan

Account: Acme Call Centers
Opportunity: Call center 24×7 upgrade
Start Date: March 2003
Commercial Qualification:
   Cost of Pain
      Clearly Identified
   Identified?
   Qualified Need
      Not Clearly Identified
   Identified?
   Possible Fit: Clearly Identified
   Owner: Aaron. CFO releases the budget Driver Event: Project No-Dropped-Calls initiated by CEO.
   Decision Date: June 2003
   Budget: $500 k
Can They Do No
Nothing?
Circle Direction: Inside-out
Commercial Sales
   Establish a beachhead
Strategy:
Closure Date: Jun. 30, 2003
   Proof of Concept and references for Bobby. Spreadsheet analysis and references Closure Event:
   for Aaron.
Discrepancies Analysis
Stakeholders with no associated Qualified Needs
{PRIVATE} Stakeholder Dudley D
Qualified Needs with no associated Qualified Needs
None
Technical Issues with no associated Subplans
{PRIVATE}
   Technical Issue
Stakeholder
Cecelia C Believes our integration approach is a band-aid
Dudley D Can't understand what our product does
Qualified Solutions with no associated Subplans
{PRIVATE}
Stakeholder Qualified Need Qualified Solution Function Product
   Call load balancing to spread out workload across Provides hot standby Bobby B Call Cluster failover CallCluster
   Analysts
Subplans with no association Tactics
None

With reference to FIG. 12, another useful report is a visual representation of the Technical Account Plan called the Technical Account Project Plan (TAPP). This graphical display is similar to an engineering project plan showing project activities, a time scale, process boxes, and activity dependencies. More specifically, in one embodiment, the TAPP lists technical decision criteria, i.e., technical issues/qualified needs, in a first column and the shows the timing for addressing each of the criteria using project activities, a time scale, process boxes, and activity dependencies.

In one embodiment, the application runs within a web browser. Any step in the left hand frame (see FIGS. 6 and 7) may be clicked, though generally the user will follow the guides and buttons presented in the right hand frame.

Reports may be copied and emailed by selecting the entire display in the right hand frame, copying it, pasting it into a word processor or email composer, and then emailing it.

An administrator is responsible for creating new databases, removing old databases, and performing database backups.

There are three major code components to the code that implements the Technical Account Planning process:
The database schema
The user interface
A Dynamic Link Library (DLL) that interfaces between the User Interface and the Database

The Database Schema

In one embodiment, the database schema is defined in a file that contains Microsoft SQL Server Transact-SQL code.

The User Interface

In one embodiment, the User Interface consists of Microsoft Internet Information Server Active Server Pages, HTML code, and JavaScript code. However, in this embodiment, the majority of the files for the User Interface are not written manually. Instead, a compiler, written in Java, examines an XML file and creates the ASP, HTML, and JavaScript files. The steps.xml file (attached as Appendix A submitted on a CD as noted above) which provides input to the Java-based User Interface compiler, gives a detailed description of the User Interface.

The Dynamic Link Library

The Dynamic Link Library (DLL) provides a programmatic interface between the Database and the User Interface. The DLL is implemented in Microsoft Visual Basic. However, the majority of the files for the DLL are not written manually. Instead, a compiler, written in Java, examines an XML file and creates the Visual Basic files.

Because of the way the DLL code is generated, the SEcycleBusinessObjects.xml file (attached as Appendix B submitted on a CD as noted above), which provides input to the Java-based DLL compiler, gives a detailed description of the DLL.

Some of the DLL's Visual Basic files are not generated from the XML file; they are hand-coded. However, the SEcycleBusinessObjects.xml file, provide enough detail to give one of ordinary skill in the art an understanding of the DLL portion of the Technical Account Planning process.

With reference to FIG. 13, a system 300 that can implement features of the present invention includes a bus or other communication means 302 for communicating information between components of the system. The system 300 further includes a processor 304 coupled to the bus 302 and a main memory, e.g., a random access memory (RAM) or other dynamic storage device 306 also coupled to the bus. The RAM stores instructions for execution by the processor 304. The main memory can also store temporary variables. The system 300 can include a mass storage device 316 coupled to the bus 302 for storing information that is not accessed as regularly as information stored in RAM.

System 300 can include a display 308 for displaying information such as advice regarding the portfolio management to a user. The system can include input devices such as a cursor control device 312 and a keyboard 310.

The system 300 can also include a communication device 314. If the system 300 is implementing one portion of one embodiment of the invention, then the communication device 314 allows the system to communicate with other portions of the system. Alternatively, if the system 300 is implementing the system on a user's personal computer or personal digital assistant, the communication device 314 can include a network card, an RF transceiver, or other well-known communication device for coupling to a network.

Alternative Embodiments

One could conceive of a number of variations regarding the Technical Sales Process Planning System. These include variations to the Technical Sales Process, Sales Engineering database, Technical Sales Process Training, Technical Account Planner, and the variety of reports.

Changes in one component of the system typically have an impact on other components. For example, a change in the technical sales process is typically reflected in the database, training, and visual interface. Similarly, a change in the training is typically reflected in the process, database, and visual interface. The four components are integral to one another and define the system.

The Sales Engineering Database: To support any improvements to the Technical Sales Process in terms of phases, steps, or SE performance measurements, it is likely the Sales Engineering Database would need to change as well. Areas of change for alternative embodiments include technical issues, competitors, issue responses, qualified solutions, technical value messages, subplans, technical tactics, workflow, suggestion making, and decision support. New entities could be added to augment the existing process in the name of developing alternative embodiments.

The Technical Account Planner: The look and feel of the user interface could vary. For example, rather than textual steps, the steps could be represented as a flow-chart.

Similarly, an alternative flow to the Technical Sales Process is contemplated as follows: One can use an engineering divide-and-conquer approach:
Opportunity information is gathered including commercial qualification, technical issues, is it real?, can we win it?, is it worth it?.
   Within the opportunity, Technical Stakeholders are identified, including profile information (personality, power, level of risk, etc). A decision process model called the Circle ofinfluence is created to visualize how to prioritize closing stakeholders and their decision criteria.
   For each stakeholder, their Decision Criteria are identified, namely technical issues and qualified needs.
      For each decision criteria, Responses are identified in the form of competitive analysis messages—objection handling, offensive strategy, and defensive strategy.
         Responses are mapped into Subplans with the goal of closing a set of decision criteria. Each subplan uses a general approach such as a proof-of-concept, reference calls, and/or a corporate visit. The collection of plans is called the Technical Account Plan alternatively known as the Technical Opportunity Plan.

Subplans consist of Tactics (activities) such as presentations, demos, meetings, phone calls, emails, and/or research.

In addition, more reports could be added such as detailed sales analysis and forecasting reports.

In alternative embodiment various labels used above could be changed. For example an entity label, a field label, or a look-up value could be changed without departing from the invention. More specific examples include the following; the Stakeholder entity could be called a Player, the Importance field could be called Priority, the issue category's lookup value Reliability could be changed to Business.

Benefits provided by embodiments of the invention include:
The Technical Account Plan results in efficient and predictable technical closures because the SE can visually track their progress against the goal
SE intelligence gathered for technical qualification is complete because the technical Account Planner specifically prompts for all required data
Missing information becomes obvious and is often flagged by the Technical Account Planner discrepancy reports
SE intelligence gathered from historical opportunities is re-used because historical data is tracked by the SErepository and presented within the Technical Account Planner
Responses to technical issues and technical value messages are aligned with stakeholder profiles because the Technical Account Planner displays stakeholder profile context information as messages are being created
Technical issues and qualified needs are addressed by tactics because the Technical Account Planner flags these discrepancies
The SE's technical fit is explicitly compared to the competition's technical fit within the Technical Account Planner's competitive fit matrix
Long and costly tactics are presented in the Technical Account Plan and Technical Account Project Plan
The SE is better able to recognize patterns of account situations so their approach and tactics become repeatable through the Technical Account Planner's automated suggestion functionality
   As a result:
Because technical qualification is complete and accurate, SEs do not waste time on accounts that are not ready to buy
SEs do not waste time on accounts that lack technical fit
SEs do not perform time intensive tasks such as presentations and demos on accounts that are unqualified
SEs stay focused on the technical close
Tactics chosen the by SE are aligned with the target stakeholder's profile such as their personality and level of risk taking
Tactic chosen the by SE measurably move the account forward
Technical sales cycles are consistent and follow the same process
Sales intelligence, strategies, and tactics from previous accounts are reused
A closed loop process enables the effectiveness of previous strategies and tactics to be considered in future account plan development as is enabled by the SErepository
SEs make the most efficient use of their time as is enabled by the Technical Sales Process Training which teaches an SE to plan his account backward from technical closure—an efficient strategy planning approach
Managers can examine SE resource utilization, performance, productivity, trends, and forecasting reports to better manage the efficiency and usage of their SEs through the Technical Account Planner's decision support functionality
Sophisticated SEs and managers can ask “ad hoc” decision support questions in anticipation of situations they might encounter in a new opportunity
The SE's “cost of sales” becomes more predictable based on empirical evidence

Having thus described at least one illustrative embodiment of the invention, various alterations, modifications and improvements are contemplated by the invention. Such alterations, modifications and improvements are intended to be within the scope and spirit of the invention. Accordingly, the foregoing description is by way of example only and is not intended as limiting. The invention's limit is defined only in the following claims and the equivalents thereto.

1. A system for managing a sales engineering process, the system comprising:
an opportunity analysis module operative to:
request information identifying an opportunity;
request information identifying at least one technical stakeholder associated with the opportunity;
request information identifying a technical issue for each technical stakeholder; and
request information identifying at least one technical issue category for the technical issue; and
a qualified needs analysis module in communication with the opportunity analysis module, the qualified need analysis module operative to:
request information selecting at least one stakeholder associated with the opportunity;
request information identifying a qualified need associated with the selected stakeholder; and
request information identifying a qualified need category for the qualified need.

2. The system of claim 1 wherein the technical issue category is selected from the group of technical issue categories consisting of:
Poor functionality fit, poor security fit, poor scalability fit, poor availability fit, poor reliability fit, poor architecture, poor design, poor requirements definition, poor project management, poor performance fit, inability to integrate or leverage investments, inability to migrate systems, poor skills or high investment to reskill, inadequate corporate organizational structure, 3rd party issues, poor standards compliance, poor operations/administration/ease of use, inability to test, poor documentation quality, inability to shift culture to ‘new world’, unable/unwilling to understand the technology, biased toward a competitor, experienced previous failure, post-sale costs and investment will be large, and the competition has a better technical fit:

3. The system of claim 1 wherein the qualified need category is selected from the group of qualified need categories consisting of:
Architecture, Design, Requirements Definition, Project Management, Performance Fit, Integration or Leveraging Investments, Migrating Systems, Skills or Reskilling, Corporate Organizational Structure, 3rd Parties, Application or Systems Functionality, Security, Scalability, Reliability, Availability, Standards Compliance, Operations/Administration/Ease of Use, Testing, Documentation Quality, Shifting the Culture to ‘New World’, Understanding the Technology, Competitive Bias, Previous Failure, Post-Sale Costs and Investment, and The Competition has a Better Technical Fit.

4. The system of claim 1 wherein the opportunity analysis module is operative to:
request information identifying a technical decision maker;
request information identifying at least one other technical stakeholder; and
request information defining at least in part a relationship between the technical decision maker and the at least one other technical stakeholder.

5. The system of claim 1 wherein the system further comprises:
a competitive analysis module in communication with the opportunity analysis module and operative to:
request information selecting a stakeholder;
request information selecting a qualified need of the stakeholder; and
request information identifying a competitor's qualified solution associated with the selected qualified need.

6. The system of claim 5 wherein the competitive analysis module is operative to:
request information selecting a technical issue; and
request information identifying a response for the selected technical issue.

7. The system of claim 1 wherein the system further comprises:
a value analysis module in communication with the opportunity analysis module and operative to:
request information selecting a stakeholder;
request information selecting a qualified need associated with the selected stakeholder;
request information determining the value of the selected qualified need; and
request information selecting a qualified solution associated with the selected qualified need.

8. The system of claim 1 wherein the system further comprises:
a technical account plan module in communication with the opportunity analysis module and operative to:
request information identifying an opportunity;
request information identifying a commercial sales strategy for the opportunity;
request information identifying a technical closing event for the opportunity;
request information identifying priority of technical stakeholders within the opportunity;
request information identifying subplans that will facilitate a sale to a technical stakeholder;
request information identifying technical tactics within subplans that will meet specific technical decision criteria for specific technical stakeholders;
request information identifying competitive messages and value messages for technical tactics to assist in meeting those technical decision criteria; and
request information identifying for each tactic: start dates, durations, resources required, and technical decision criteria to be met.

9. A sales engineering process comprising:
performing an opportunity analysis including:
identifying an opportunity;
identifying at least one technical stakeholder associated with the opportunity;
for each technical stakeholder, identifying a technical issue; and
identifying at least one technical issue category for the technical issue; and
performing a qualified needs analysis associated with the opportunity analysis including:
selecting at least one technical stakeholder;
identifying a qualified need associated with the selected technical stakeholder; and
identifying a qualified need category for the qualified need.

10. The sales engineering process of claim 9 wherein the technical issue category is selected from the group of technical issue categories consisting of:
Poor Functionality Fit, Poor Security Fit, Poor Scalability Fit, Poor Availability Fit, Poor Reliability Fit, Poor Architecture, Poor Design, Poor Requirements Definition, Poor Project Management, Poor Performance Fit, Inability to Integrate or Leverage Investments, Inability to Migrate Systems, Poor Skills or High Investment to Reskill, Inadequate Corporate Organizational Structure, 3rd Party Issues, Poor Standards Compliance, Poor Operations/Administration/Ease of Use, Inability to Test, Poor Documentation Quality, Inability to Shift Culture to ‘New World’, Unable/Unwilling to Understand the Technology, Biased Toward a Competitor, Experienced Previous Failure, Post-Sale Costs and Investment will be Large, and The Competition has a Better Technical Fit.

11. The sales engineering process of claim 9 wherein the qualified need category is selected from the group of qualified need categories consisting of:
Architecture, Design, Requirements Definition, Project Management, Performance Fit, Integration or Leveraging Investments, Migrating Systems, Skills or Reskilling, Corporate Organizational Structure, 3rd Parties, Application or Systems Functionality, Security, Scalability, Reliability, Availability, Standards Compliance, Operations/Administration/Ease of Use, Testing, Documentation Quality, Shifting the Culture to ‘New World’, Understanding the Technology, Competitive Bias, Previous Failure, Post-Sale Costs and Investment, and The Competition has a Better Technical Fit.

12. The sales engineering process of claim 9 wherein the identifying at least one technical stakeholder comprises:
identifying a technical decision maker; and
identifying at least one technical stakeholder who has a relationship with the technical decision maker.

13. The sales engineering process of claim 9 wherein identifying at least one technical stakeholder comprises:
identifying a technical decision maker;
identifying at least one other technical stakeholder; and
defining at least in part a relationship between the technical decision maker and the at least one other technical stakeholder.

14. The sales engineering process of claim 9 wherein the process further comprises performing a competitive analysis associated with the opportunity analysis, perfuming the competitive analysis including:
selecting a stakeholder;
selecting a qualified need of the stakeholder; and
identifying a competitor's qualified solution associated with the selected qualified need.

15. The sales engineering process of claim 14 wherein performing a competitive analysis further comprises:
selecting a technical issue; and
identifying a response for the selected technical issue.

16. The sales engineering process of claim 9 wherein the process further comprises:
performing a value analysis associated with the opportunity analysis, performing the value analysis including:
selecting a stakeholder;
selecting a qualified need associated with the selected stakeholder;
determining the value of the selected qualified need; and
selecting a qualified solution associated with the selected qualified need.

17. The sales engineering process of claim 9 wherein the process further comprises:
developing a technical account plan associated with the opportunity analysis, developing the technical account plan including:
identifying an opportunity;
identifying a commercial sales strategy for the opportunity;
identifying a technical closing event for the opportunity;
identifying priority of technical stakeholders within the opportunity;
identifying subplans that will facilitate a sale to a technical stakeholder;
identifying technical tactics within subplans that will meet specific technical decision criteria for specific technical stakeholders;
identifying competitive messages and value messages for technical tactics to assist in meeting those technical decision criteria; and
identifying for each tactic: start dates, durations, resources required, and technical decision criteria to be met.

18. A method for training a sales engineer, the method comprising instructing the sales engineer to:
perform an opportunity analysis including:
identifying an opportunity;
identifying at least one technical stakeholder associated with the opportunity;
for each technical stakeholder, identifying a technical issue; and
identifying at least one technical issue category for the technical issue; and
perform a qualified needs analysis associated with the opportunity analysis, performing the qualified needs analysis including:
selecting at least one stakeholder;
identifying a qualified need associated with the selected stakeholder; and
identifying a qualified need category for the qualified need.

19. The method of claim 18 wherein the technical issue category is selected from the group of technical issue categories consisting of:
Poor Functionality Fit, Poor Security Fit, Poor Scalability Fit, Poor Availability Fit, Poor Reliability Fit, Poor Architecture, Poor Design, Poor Requirements Definition, Poor Project Management, Poor Performance Fit, Inability to Integrate or Leverage Investments, Inability to Migrate Systems, Poor Skills or High Investment to Reskill, Inadequate Corporate Organizational Structure, 3rd Party Issues, Poor Standards Compliance, Poor Operations/Administration/Ease of Use, Inability to Test, Poor Documentation Quality, Inability to Shift Culture to ‘New World’, Unable/Unwilling to Understand the Technology, Biased Toward a Competitor, Experienced Previous Failure, Post-Sale Costs and Investment will be Large, and The Competition has a Better Technical Fit.

20. The method of claim 18 wherein the qualified need category is selected from the group of qualified need categories consisting of:
Architecture, Design, Requirements Definition, Project Management, Performance Fit, Integration or Leveraging Investments, Migrating Systems, Skills or Reskilling, Corporate Organizational Structure, 3rd Parties, Application or Systems Functionality, Security, Scalability, Reliability, Availability, Standards Compliance, Operations/Administration/Ease of Use, Testing, Documentation Quality, Shifting the Culture to ‘New World’, Understanding the Technology, Competitive Bias, Previous Failure, Post-Sale Costs and Investment, and The Competition has a Better Technical Fit.

21. A memory for storing data for access by an application program being executed on a data processing system, comprising:
a data structure stored in the memory, the data structure including information resident in
a database used by the application program, the database including:
an opportunity entity including fields for: identifying an opportunity; identifying at least one technical stakeholder associated with the opportunity; for each technical stakeholder, identifying a technical issue; and identifying at least one technical issue category for the technical issue; for identifying a technical decision maker;
a qualified solution entity associated with the opportunity entity, the qualified solution entity including fields for: identifying a qualified need associated with a technical stakeholder; and identifying a qualified need category for the qualified need;
a subplan entity associated with the opportunity entity, the subplan entity entity including fields for identifying at least one subplan associated with an opportunity; and
a tactic entity associated with the subplan entity, the tactic entity including fields for identifying tactics associate with a subplan.
